(19) United States
(12) Patent Application Publication
(10) Pub. No.: US 2022/0361540 A1
(43) Pub. Date: Nov. 17, 2022

(54) PACKAGED FISH CONSUMER PRODUCT

(71) Applicant: Damion Robinson, Jonesboro, GA (US)

(72) Inventor: Damion Robinson, Jonesboro, GA (US)

(21) Appl. No.: 17/318,262

(22) Filed: May 12, 2021

(51) Int. Cl. A23L 17/00; A23L 19/00; A23L 15/00; A23L 7/157; A23B 4/06; B65B 25/06; B65B 31/04

(52) U.S. Cl. CPC A23L 17/70; A23L 19/03; A23L 15/30; A23L 7/157; A23B 4/06; B65B 25/062; B65B 31/048; A23V 2002/00

(57) ABSTRACT

Disclosed is a food product comprising a packaged quantity of raw fish, the fish having been combined, in the preferred embodiment, with diced vegetables, egg whites, seasonings, and other selected ingredients, thereby forming a food mixture. The entirety of the food mixture is inserted into a container, the container comprising a semi-elastic material and having the contour of an oblong, oval-shaped tubular food casing. Thereupon, the tubular food casing is sealed in an airtight manner. The tubular food casing, may also be vacuum sealed. The container may further be subjected to a process of flash freezing. The sealed tubular food casing, upon being accessed, may be thawed or reduced in temperature so as to allow a consumer to cut individually-sized sections of the tubular food casing for cooking in any selected manner, including baking, broiling, or frying.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the present inventive concept relates generally to methods and processes utilized to prepare, process, and store a fish product, preferably salmon, for immediate cooking and/or consumption by a person.

In general, creating a new food or drink recipe involves usually sequential processes. First, trying to find an appropriate combination and optimum quantify of ingredients, secondly, upon finding a new combination, applying the new combination in a recognized or familiar recipe, and thirdly, deciding on the most efficient and convenient means of preparing the recipe in a tasteful, appealing manner for the ultimate consumer.

### (2) Description of the Related Art, Including Information Disclosed Under 37 CFR 1.97 and 1.98.

The following presents references and materials which may bear some similarity to the disclosed inventive concept. Some of the references, which may include patents, patent applications and various publications, may be cited and discussed in the description of this inventive concept. The citation and/or discussion of such references is provided merely to clarify the description of the present invention and is not an admission that any such reference is “prior art” to the inventive concept presented herein. All references cited and discussed in this specification are incorporated herein by reference in their entireties and to the same extent as if each reference was individually incorporated by reference.

U.S. patent application Ser. no. 4,762,722; (lzumimoto, et al Aug. 9, 1988). A sealed package for inhibiting the oxidation and spoilage of raw meat or fish, while maintaining the scarlet color of the raw meat or fish. This package comprises an impermeable vessel housing a deoxidant-CO.sub.2 generating agent composition together with the raw meat or fish. The deoxidant-CO.sub.2 generating agent composition is selected to generate CO.sub.2 gas immediately after the initiation of O.sub.2 absorption at the rate of 0.2 to 2 enols per mol of O.sub.2 absorbed.

U.S. Pat. No. 45,482,725; (Cavicchiolo, Jan. 9, 1996). The food product comprises an arrangement of parallel elongate lengths of a hollow alimentary paste product (1b) connected together. The ends (5) of the lengths constitute a first surface on one side of the arrangement and can be closed. The arrangement can be enclosed in a plastic wrapping (3) capable of withstanding cooking and provided with openings (4). In one method of manufacture, the lengths are arranged in the desired form, the fiat surface is wetted and slight pressure is exerted on the sides of the assembled lengths. In another method of manufacture, an arrangement of lengths of the product (1b) is placed in a plastic wrapping (3). The food product thus formed is firm and is easily transportable after cooking. It can be eaten without implements and without mess, by holding it in the hand like a sandwich or hamburger, even if it contains sauce. It can also be used as a new form of pasta.

U.S. Pat. No. 5,817,353 (Guarino, N. Oct. 6, 1998). A process and packaging for shellfish and other seafood, including the use of pallet structure for positioning the product within the packaging to avoid penetration by shells, fish bones or fins of the plastic wrapping film to enable the product to be preserved by flat packing and vacuum sealing and then placed within an outer package designed to promote a pleasing appearance of the product within.

U.S. Published Patent Application #2017/0121041 (Jari, Ruuttu; May 4, 2017). A method for packing a fish product (39), and a fish product package. The method comprises packing the fish product (39) in a vacuum package, arranging in said vacuum package an empty space (43), forming in the vacuum package by means of empty space (43) an underpressure, and maintaining the empty space (43) in the package, the underpressure generating pressure on the fish product (39).

### BRIEF SUMMARY OF THE INVENTION

The inventive concept disclosed is a unique process and method to provide fresh fish patties, or croquettes, having complementary seasoning ingredients, in a sealed, pre-mixed, airtight wrap for immediate availability for cooking in a desired manner by a cook. or the ultimate consumer. The disclosed methods are directed primarily toward providing food staples at the breakfast meal.

Consumers usually prefer their personalized meal, food or drink optimized for health, taste, and appetite. It is noted that breakfast foods span a wide range of choices and often depend on the prospective diner's mood and time available for food preparation. Consumers and even food professionals don't have the knowledge, nor time to customize a dish for each occasion of breakfast consumption. Kitchen tools can partially take on this role, as well as seasonings and other compatible foodstuffs such as fruits and vegetables.

In the United States, over the past two decades, a multiple selection of various foods for breakfast are now enjoyed. These include such unique selections as breakfast quesadillas, sliders casseroles, and breakfast “bowls.” Fish is a breakfast staple in countries around the world, from the United Kingdom to japan, and to a certain extent, in the United States.

Starting the day with some combination of fish for breakfast has many health benefits, including the intake of two essentially fatty acids, eicosapentaenoic acid (EPA) and docosahexaenoic acid (DHA), both omega-3 fatty acids that the human cardiovascular system needs.

A 3-ounce portion of wild caught salmon contains 1,716 mg of DHA, way less than what its fish oil counterpart contains (4,767 mg per tablespoon). Salmon can be fried, grilled, baked or smoked, and such cooking will not affect its DHA content. Other vitamins and minerals essential in overall health are also found in wild caught salmon.

DHA is not naturally produced by one body. Therefore, to get DHA that will promote better brain and heart health and help Maintain good overall health, health experts have determined that every person should make an effort to eat foods containing this omega-3 fatty acid. Plant seeds and several kinds of fish, as well as fish oils are the bet sources of DHA.

One object of this invention is to provide fish and, in the preferred embodiment, salmon, in desirable packaging to promote favorable product appearance on a scale not heretofore realized.

Another object of the present invention is to provide a sealed package of raw fish, in the preferred embodiment, salmon, capable of maintaining, a scarlet color of the fresh raw fish even in the absence of oxygen and of inhibiting the oxidation and spoilage of the raw fish., thereby keeping its original high quality over a long period of time. Raw fish packaged properly can he maintained and preserved without losing the freshness thereof.

The longitudinal seam 6 of the tubular food casing 5 may have a glued, permanent: fastening, a stitched fasWning, a heat-scaled fastening, or other means of fastening, and may be coated with acrylic, collagen and/or other suitable material.

### BRIEF DESCRIPTION OF THE VIEWS OF DRAWINGS AS EXEMPLARY EMBODIMENTS OF THE INVENTIVE CONCEPT

FIG. 1 is a perspective view of the packaged food product 1, shaped in the contour of a tubular food casing 5 of semi-elastic material 4.

FIG. 2 depicts a view looking parallel to the axis of the packaged food product 1, further showing a first listener 2 binding the outer surface 10 of the semi-elastic material 4 at the first end 7 of the packaged food product 1.

FIG. 3 is a cross-sectional view of the packaged food product 1 as seen from the orientation of section line 1-1 of FIG. 1.

FIG. 4 illustrates the profile and appearance of a single patty 9 cut from the packaged food product 1.

FIG. 5 illustrates the sequential steps of the manual process by which the packaged food product 1 is packaged according to the subject invention.

### DETAILED DESCRIPTION OF THE INVENTION

The objects, features, and advantages of the inventive concept presented in this application are more readily understood when referring to the accompanying drawings. The drawings, totaling five figures, show the basic components and functions of embodiments and/or methods of use. In several figures, like reference numbers are used in each figure to correspond to the same component as may be depicted in other figures.

The primary objective of this inventive concept is to provide a process and packaging to make available a pre-packaged salmon 25 mixture as a main entre or a complementary food selection. The resulting packaged food product 1 is offered to the consumer for immediate cooking and consumption, from retail packaging heretofore unavailable to the consumer.

The packaged food product 1 comprises a consumer-ready quantity of raw fish 20, the raw fish 20 having been combined, in the preferred embodiment, into a mixture 23 further containing various chopped vegetables 21, foodstuffs 2, and a variety of seasonings.

Another objective in the process of creating the packaged food product 1 is to control the shape, contour, and quantity of the final product. When engaging in a manual process of creating the packaged food product 1, it is necessary to begin with a first, measured quantity of the raw fish 20, or, in the preferred embodiment, raw, trimmed salmon 25.

A final objective is to place theentirety of the mixture 23 onto an appropriately-dimensioned, flat sheet of a semi-elastic material 4. The semi-elastic material 4 is then arranged into a tubular food casing 5, which is sealed longitudinally 6 and at both ends 8, 9. Where the necessary equipment is available, the tubular food casing 5 may be vacuum sealed. The tubular food casing 5 should then be subjected to a flash freezing process

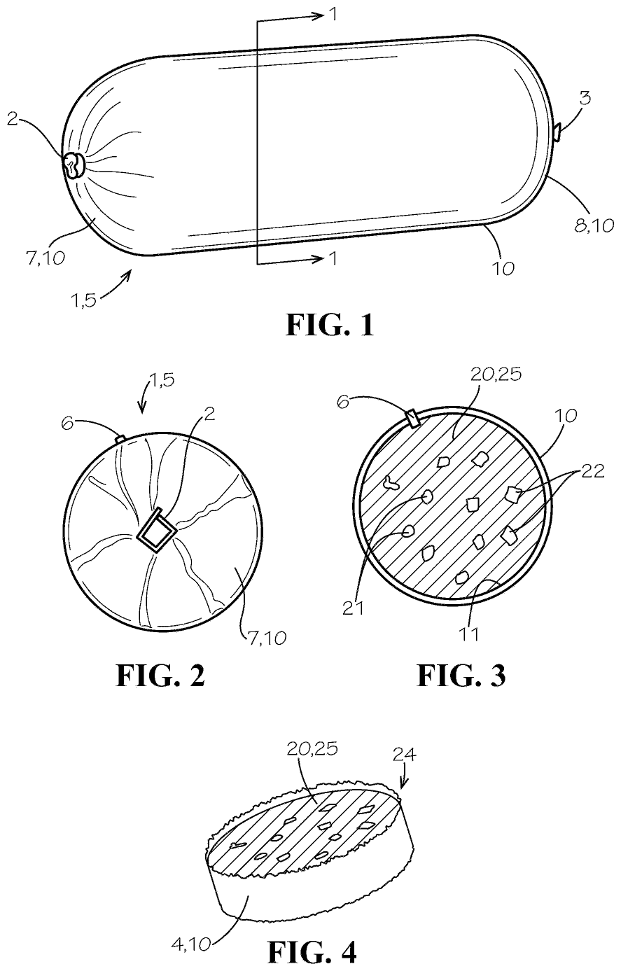

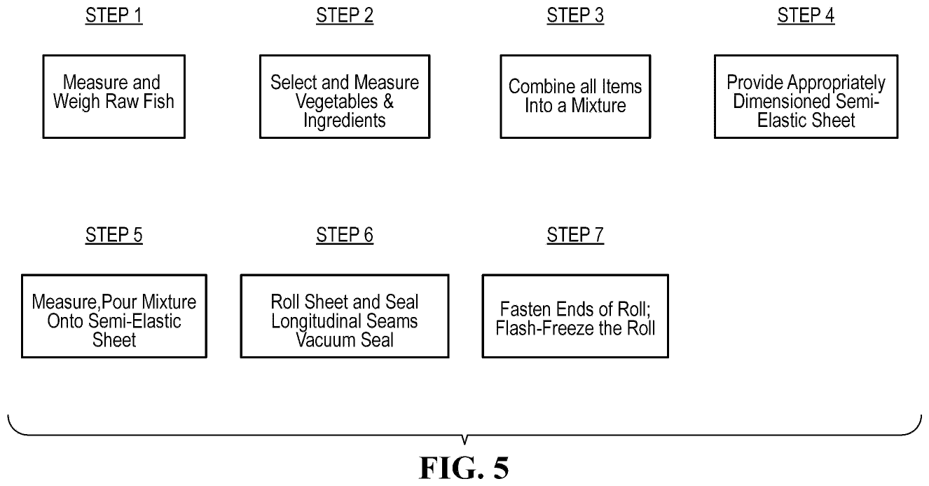

The discussion of the present inventive concept will be initiated with FIG. 1. In FIG. 1 there is illustrated a perspective view of the preferred embodiment of the packaged food product 1 disclosed herein.

In the preferred embodiment of the packaged product 1, the preparation of the mixture 23 begins with the providing of approximately one pound of raw, fully trimmed salmon 25 as the raw fish 20 component. Other embodiments of the inventive concept increase the quantity or weight of the fully trimmed salmon 25. The trimmed salmon 25 must be separated into small bits. The inventive concept, calls for the use of additional ingredients, these ingredients proportional to inclusion of one pound of raw fully trimmed salmon 25, as indicated in the following t\list.

A component of the mixture 23 includes vegetable particles 21, which may include, but are not limited to, onions and celery.

A second component of the mixture 23 includes foodstuff 22 items, which may include, but are not limited to, flavored cornbread mix, and the white of one egg.

Another component of the mixture 23 includes seasonings 26, which may include, but are not limited to, salt, black pepper, and Old Bay® seasoning.

Proportional to the use of one pound of raw, fully trimmed salmon 25, the following quantities or amounts of the ingredients of the mixture are preferred:

one-half teaspoon of salt;

one teaspoon of black pepper;

half-teaspoon of Old Bay® seasoning;

one-half cup celery;

one-half cup of chopped onions;

flavored cornbread mix, or breading, using amounts as necessary; and the White of one egg.

To prepare the mixture 23, combine, in a medium-size mixing bowl, or other suitable container, all the above-listed ingredients and mix until the ingredients are well kneaded together. The resulting mixture 23 is then set for pouring onto a flexible, semi-elastic sheet 4, which sheet will ultimately form the outer surface 10 and inner surface 11 of a tubular food casing 5. The semi-elastic sheet 4, is approximately ten (10.0) inches in length, by eight (8.0) inches in width, and 0.0005 inches, (or 12.7 micrometers) thick. Either a manual process, or a fully automated process may be used to pour and shape the tubular food casing 5 comprising the final packaged food product 1.

By utilization of this thickness, a consumer may more readily use a serrated knife to slice through the packaged food product to fashion conveniently-sized patties 9 suitable for individual cooking and serving.

While preferred embodiments of the present inventive method have been shown and disclosed herein, it will be obvious to those persons skilled in the art that such embodiments are presented by way of example only, and not as a limitation to the scope of the inventive concept. Numerous var:iations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein, Accordingly, it is intended that this inventive concept be inclusive of such variations, changes, and substitutions, as described by the scope of the claims presented herein,

What is claimed is:

1. A food product comprising a packaged quantity of raw fish, the raw fish having been combined, in the preferred embodiment, into a mixture further containing various foodstuffs, and the entirety of the mixture being inserted into at least one container in the contour of an oblong tubular food casing, the at least one oblong tubular food casing comprising a semi-elastic material, the oblong tubular food casing thereafter being sealed, forming a packaged food product.

2. The food product of claim 1 wherein the raw fish consists of salmon.

3. The food product of claim 1, wherein the various foodstuffs comprise diced vegetables, egg whites, and seasonings.

4. The food product of claim 1 wherein, upon insertion of the mixture into the at least one oblong, tubular food casing, the oblong, tubular food casing is subjected to a vacuum sealing process.

5. The food product of claim 1 wherein, upon insertion of the mixture into the at least one container and the at least one container being sealed, the at least one container is subjected to flash freezing.

6. A process for packaging and storage of a pre-mixed food substance, comprising the steps of:
providing raw fish that has been pre-cut and broken into small pieces;
providing a plurality of egg whites;
providing a quantity of cornbread mix, or breading;
providing a mixture consisting of a quantity of diced vegetables;
combining the raw fish, egg whites, breading, and vegetables in a shallow bowl;
adding selected seasonings to the combined raw fish, egg whites, breading, and diced vegetables, thereby forming a food mixture;
placing the food mixture into an oblong container, contoured in the shape of a tubular food casing, the casing comprising an impermeable, semi-elastic material; and
rendering the tubular food easing airtight, by means of vacuum sealing; and
subjecting the tubular food casing to a flash freeze process.

7. The process of claim 6, wherein the raw fish consists of salmon.
